(19) United States
(12) Patent Application Publication
(10) Pub. No.: US 2010/0107488 A1
(43) Pub. Date: May 6, 2010

(54) Flower Pot Supporting Umbrella Means Apparatus

(76) Inventors: Alison Brooke King, Wallace, NC (US); Vaughn M. King, Wallace, NC (US)

Correspondence Address: The Law Offices Of Mark S.King, P.C, 2018 Eastwood Road, Suite # 204, Wilmington, NC, 28403, US

(21) Appl. No.: 12/612,991

(22) Filed: Nov. 5, 2009

Related U.S. Application Data
(60) Provisional application No. 61/198,321, filed on Nov. 6, 2008.

(51) Int. Cl. A01G 13/02; A45B 11/00

(52) U.S. Cl. 47/20.1; 135/16

(57) ABSTRACT

A flower pot apparatus adapted for enveloping the base of an umbrella pole in such a manner as to allow the flower pot apparatus to primarily support the umbrella when the flower pot is filled with plant growth media. The flower pot apparatus when coupled with an umbrella functions to shield the contents of the flower pot from precipitation and direct sunlight as needed to nurture the growth and development of a plant contained therein or to protect such other contents as may be contained therein. The flower pot apparatus when coupled with an umbrella secondarily functions as a household decoration.

### CROSS-REFERENCE TO RELATED APPLICATIONS

This application claims the benefit of U.S. Provisional Application Ser. No. 61/198,321 filed Nov. 6, 2008, which is hereby incorporated by reference in its entirety.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

The present invention is in the technical field of plant husbandry. More particularly, the present invention pertains generally to flower pots or planters, and more specifically to a pot that is self-supported and freestanding, having means to support an otherwise freestanding umbrella.

2. Background Art

Household gardening and the maintenance of domesticated plants in flower pots and planters is both a pastime practiced around the globe and a practiced method of improving the general appearance of and decorating in and around a home. In terms of domesticated plants, it is well known that varying species of plants require varying degrees of watering and sunlight exposure to maximize the growth and overall health of the plant. Accordingly, many domesticated plants, although desirable as decorative elements surrounding a home, may be incapable of sustaining when placed outside and exposed to a particular climate wherein the plant receives excess precipitation or sunlight.

Because outdoor decorative plants do not all require the same amount of precipitation and sunlight, it would be a benefit to have a flowerpot apparatus that limits or regulates the amount of precipitation and/or sunlight to which individual decorative plants are exposed. It would be a further benefit for said flowerpot apparatus to serve a decorative purpose in and of itself as well.

The use of flower pot devices to regulate the precipitation and air available to soil or other plant media contained within a flower pot or planter is known in the prior art. U.S. Pat. No. 4,435,918 (the “918 Patent”) describes a flower pot system having a means to regulate the water supply to soil and a means that can adjust the exposed area of the soil to the air, thereby minimizing the unfavorable effect of the drastic changes of the weather. Although the system disclosed in the 918 Patent fulfills its respective objectives, it does so at the risk of making the flowerpot itself awkward or unsightly in appearance. Further, the system disclosed in the 918 Patent fails to account for the plant itself, which remains fully exposed to the elements. Accordingly, the need remains for a flowerpot or planter apparatus that accomplishes the goals of limiting the exposure of a domesticated plant to falling precipitation and sunlight while not becoming an eyesore itself. A design wherein the flowerpot or planter houses and supportively engages a functional and decorative umbrella designed to shield a contained plant from excess precipitation and sunlight is thus desirable.

The use of flowerpot devices coupled with an umbrella is known in the prior art. U.S. Pat. No. 4,821,454 (the “454 Patent”), U.S. Pat. No. 5,960,587 (the “587 Patent”), U.S. Pat. No. 6,161,333 (the “333 Patent”), and U.S. Pat. No. 7,155,860 (the “860 Patent”) each disclose their own respective embodiments of a flowerpot or planter designed to engage the pole of an umbrella. Again, while the devices disclosed in the above referenced patents fulfill their respective, particular objectives and purposes, each contemplates the use of the umbrella in a patio furniture context, the umbrella most often extending upward through the center of a patio table, and the flower pot or planter is designed and employed as a decorative center piece on the table or as a decorative element supported by and affixed to the pole of the umbrella. Accordingly, the need remains for am apparatus wherein an umbrella is a functional feature of and supported by the flower pot or planter itself, its intended utility relating to the regulation of precipitation and sunlight reaching the flower pot and contained plant media.

### BRIEF SUMMARY OF THE INVENTION

It is thus an object of the present invention to provide a flower pot or planter apparatus having means to supportively engage an umbrella pole, wherein the umbrella is a feature of the apparatus for the express purpose of limiting or regulating the amount of precipitation and sunlight to which the flower pot or planter and its contents are exposed.

It is a further object of the present invention to provide the contemplated flower pot or planter having means to supportively engage an umbrella pole in such a way that the apparatus itself may be placed as a functional and decorative feature in an outdoor are where admirers may congregate.

The present invention meets the above stated objects by generally comprising a flower pot or planter having structural support means wherein the pole of an umbrella may be accepted and supportively engaged when the flower pot or planter contains a plant and/or plant media. The present invention further meets the above stated objects by design allowing the removal and interchange of multiple umbrellas of varying function, color, size, and style as a user may dictate upon determination of a plant's need for more or less watering and sunlight exposure or upon a user's opinion in terms of the present invention as a decorative element.

### BRIEF DESCRIPTION OF THE SEVERAL VIEWS OF THE DRAWING

FIG. 1A is a side view of the exemplary embodiment of the flowerpot supporting umbrella apparatus.

FIG. 1B is a side cross-sectional view of the exemplary embodiment depicted in FIG. 1A.

FIG. 2A is a side cross-sectional exploded view of an alternative embodiment of the flowerpot supporting umbrella apparatus.

FIG. 2B is a partial side cross-sectional exploded view of the alternative embodiment depicted in FIG. 2A.

FIG. 3 is a side view of a second alternative embodiment of the flowerpot supporting umbrella apparatus.

FIG. 4A is a side view of a third alternative embodiment of the flowerpot supporting umbrella apparatus.

FIG. 4B is a top view of the flowerpot in the alternative embodiment depicted in FIG. 4A.

FIG. 5A is a top view of a third alternative embodiment of the flowerpot supporting umbrella apparatus.

FIG. 5B is a side cross-sectional view of the alternative embodiment depicted in FIG. 5A.

### DETAILED DESCRIPTION OF THE INVENTION

Before the present flowerpot supporting umbrella apparatus is described, it is to be understood that this invention is not limited to a particular flower pot supporting umbrella apparatus, as such may, of course, vary. It is also understood that the terminology used herein is for the purpose of describing particular embodiments only, and is not intended to be limiting as the scope of the present invention will be limited only by the appended claims.

Unless defined otherwise, all terms used herein have the same meaning as commonly understood by one of ordinary skill in the art to which this invention belongs.

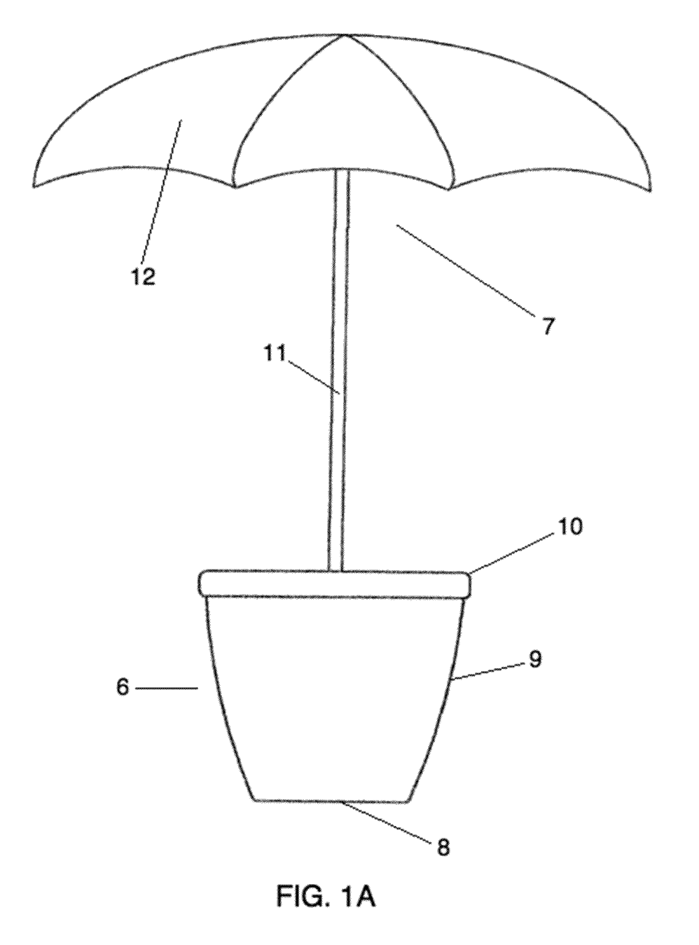

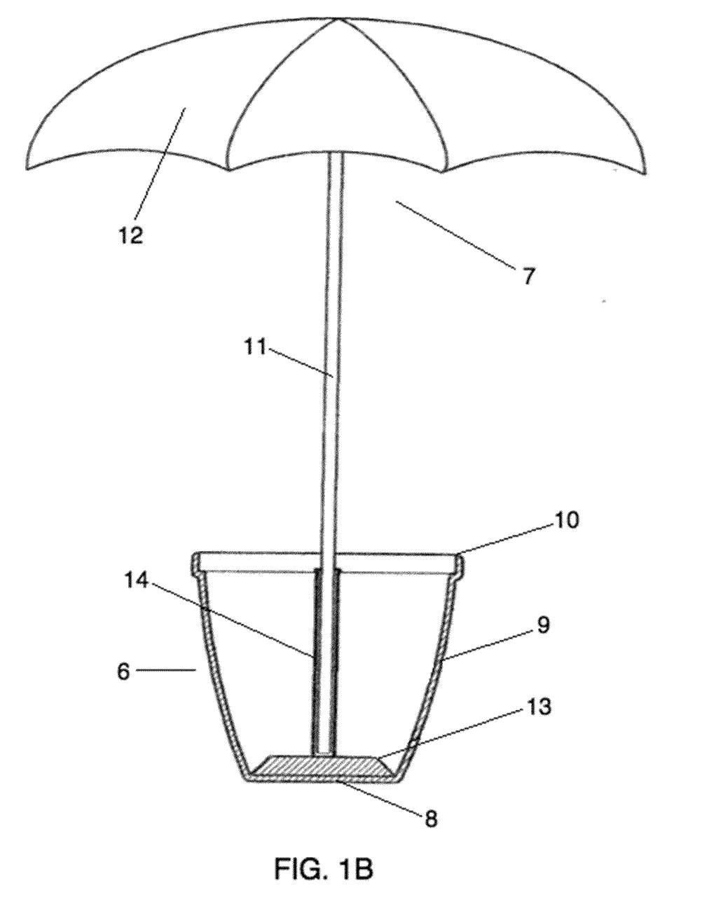

Referring now to the flower pot supporting umbrella apparatus in more detail, in FIG. 1A through FIG. 5B there are shown varying views and embodiments of a vessel 6 having a bottom wall 8 and a perimeter wall 9 being attached to and extending upwardly from said bottom wall 8, said perimeter wall 9 having an upper edge 10 defining an opening at the top of the vessel 6, said vessel 6 having means to supportively engage the pole 11 of an umbrella 7 such that the umbrella 7 is completely supported in a standing position by the vessel 6 and a canopy 12 at the apical terminus of the umbrella 7 is positioned so as to shade and limit the amount of precipitation that may reach the vessel 6 and its contents.

FIG. 1A and FIG. 1B shows an exemplary embodiment of the flower pot apparatus comprising a vessel 6 having a bottom wall 8 and a perimeter wall 9 being attached to and extending upwardly from said bottom wall 8, said perimeter wall 9 having an upper edge 10 defining an opening at the top of the vessel 6, said bottom wall 8 further having a cylindrical hollow shaft 14 extending vertically upward from the geometric center of a base 13 congruent with and attached to the bottom wall 8, the cylindrical hollow shaft 14 having an upper edge defining an opening at the top of the shaft 14. The hollow shaft 14 supportively envelops the vertical pole 11 of an umbrella 7 extending upward from the shaft 14 and vessel 6. The base terminus of the pole 11 of the umbrella 7 rests upon the top plane of the base 13 and is supportively enveloped by the hollow shaft 14 along the length of the pole 11 to the upper edge of the shaft 14, the upper edge of the shaft 14 being positioned such that the shaft 14 does not protrude beyond the horizontal plane of the upper edge 10 of the vessel 6.

In more detail, still referring FIG. 1A and FIG. 1B, the flower pot supporting umbrella apparatus is free-standing with the umbrella 7 and its canopy 12 being of sufficient size and surface area to deflect precipitation and sunlight from direct contact with the vessel 6 and any contents thereof. Further, the flower pot supporting umbrella apparatus is free-standing with the vessel 6, base 13, and hollow shaft 14 collectively supporting the umbrella 7, as opposed to the inverse relationship of favor in the prior art wherein an umbrella is the physically dominant feature of a coupling with a pot or planter and the umbrella supports the pot or planter.

In further detail, still referring to FIG. 1A and FIG. 1B, the vessel 6 is of sufficient volume to contain a plant and potting soil or other plant media. The base 13 from whence the hollow shaft 14 extends upward is constructed of a rigid and strong homogenous material, such as high-strength plastic, metal, wrought iron, wood, or the like, and is of sufficient dimension to support the hollow shaft 14 and withstand the structural stress created when the shaft 14 engages the umbrella pole 11. Likewise, the shaft 14 is constructed of a rigid and strong homogenous material, such as high-strength plastic, metal, wrought iron, wood, or the like, and is of sufficient dimension to engage the umbrella pole 11 and bear the weight and structural stresses attendant to supporting the umbrella 7, a sufficient length of the shaft 14 being between 25 and 100 percent of the height of the upper edge 10 of the vessel 6.

In further detail and still referring to FIG. 1A and FIG. 1B, the umbrella 7 is of sufficient length in relation to the vessel 6 as to not contact or interfere with the vessel 6 nor its contents. Further, the umbrella canopy 12 is of sufficient dimensions, including but not limited to surface area, to shelter the entirety of the vessel 6 and its contents from precipitation and sunlight.

In the exemplary embodiment depicted in FIG. 1A and FIG. 1B, the base 13 and connected hollow shaft 14, although always contemplated to be permanently affixed to one another, may collectively be a permanent and molded feature of the vessel 6 or, the base 13 and shaft 14 may be a feature independent of the vessel 6, removable from the vessel 6 and interchangeable in any alternative vessel 6 of sufficient size to allow the base 13 to rest flat against the bottom wall 8 of the alternative vessel 6 in a structurally stable manner.

The structural composition of the apparatus as depicted in FIG. 1A and FIG. 1B is of a high-strength, high-density plastic or of any other sufficiently rigid and strong material such as metal, wrought iron, wood, concrete, terra cotta or other hardened clay, and the like. Likewise, the umbrella pole 11 may be composed of any combination of rigid and strong material (i.e., high-strength plastic, metal, wrought iron, wood, and the like) so long as the pole 11 remains sufficiently rigid to bear the weight of the canopy 12, particularly in inclimate weather conditions. The canopy 12 of the umbrella 7 may be composed of a strong and rigid material (i.e., high-strength plastic, metal, wrought iron, wood, and the like) or may be composed of a pliable material such as a lightweight plastic, rubber or textile composition stretched over rigid support arms as found in a traditional umbrella canopy radiating outward from the juncture of the canopy 12 and the pole 11 of the umbrella 7.

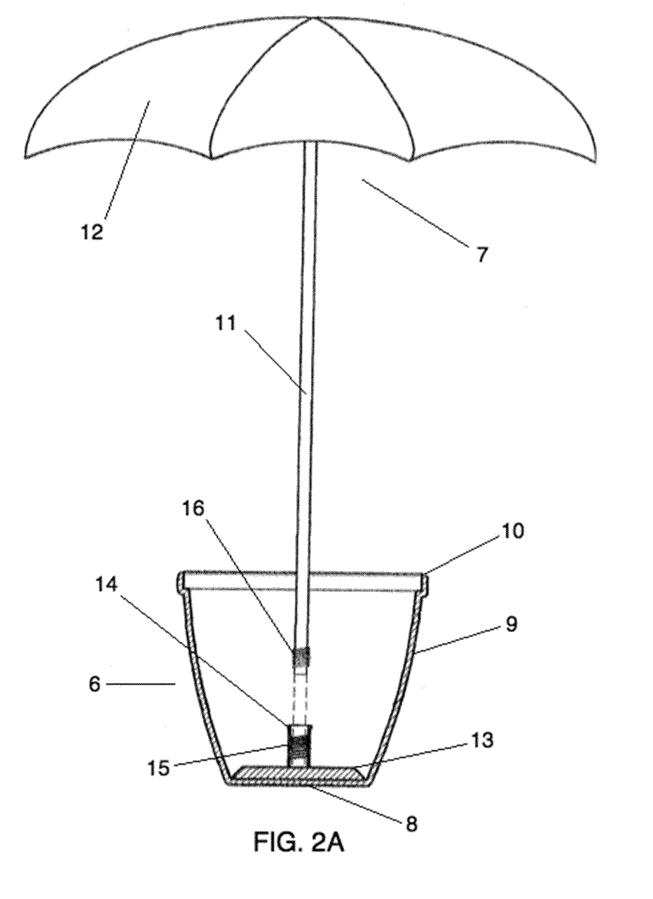

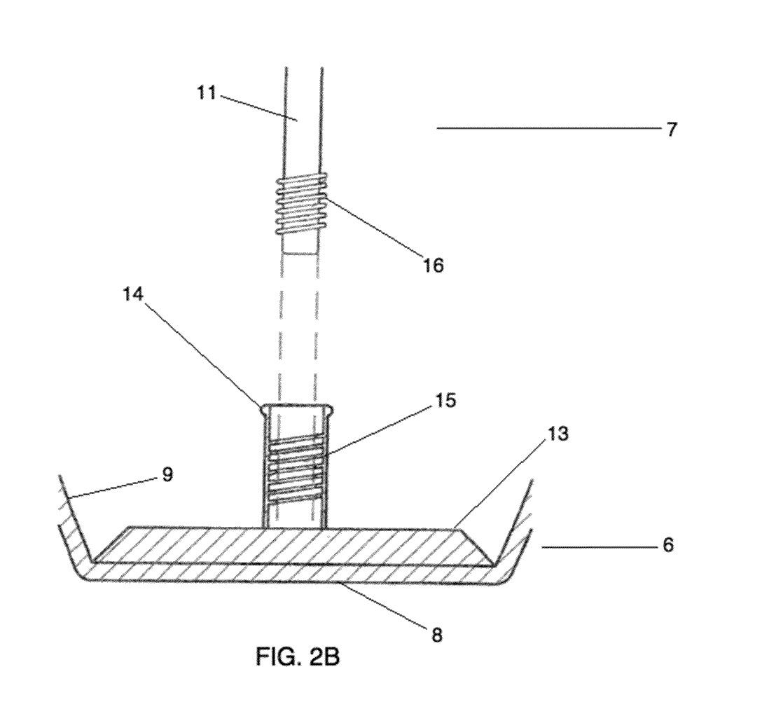

An alternative exemplary embodiment is depicted in FIG. 2A and FIG. 2B, wherein there is shown a truncated hollow shaft 14 of the form and type above described, containing on its inner face a spiraled thread track 15 designed to compliment and supportively interact with a complimentary spiraled thread track 16 featured on the outer face of the base terminus of the umbrella pole 11, thus allowing the umbrella 7 to be rigidly screwed into position when inserted into the shaft 14.

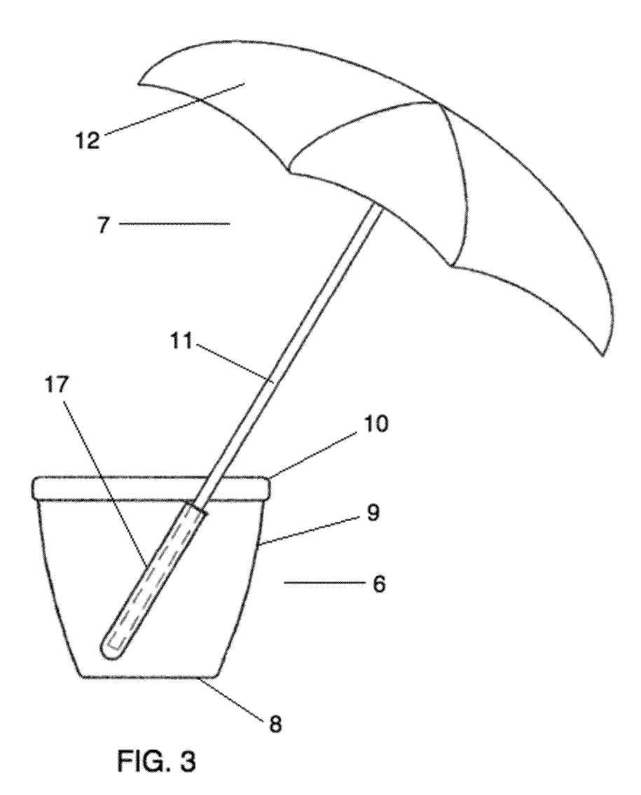

Referring now to FIG. 3, there is shown an alternative embodiment of the present invention comprising a vessel 6 having a bottom wall 8 and a perimeter wall 9 being attached to and extending upwardly from said bottom wall 8, said perimeter wall 9 having an upper edge 10 defining an opening at the top of the vessel 6, having a diagonal hollow shaft 17 having an upper edge defining an opening at the top of the shaft 17 attached to the outer surface of the perimeter wall 9, said shaft 17 supportively enveloping the pole 11 of an umbrella 7 extending upward from the vessel 6 at the diagonal orientation dictated by the shaft 17. The base terminus of the shaft 17 is closed and the base terminus of the pole 11 of the umbrella 7 rests upon the inner face of the closed base terminus of the shaft 17, supportively enveloped by the shaft 17 along the lower length of the pole 11 to the upper edge of the shaft 17, said upper edge of the shaft 17 being such that the shaft 17 does not protrude beyond the horizontal plane of the upper edge 10 of the vessel 6.

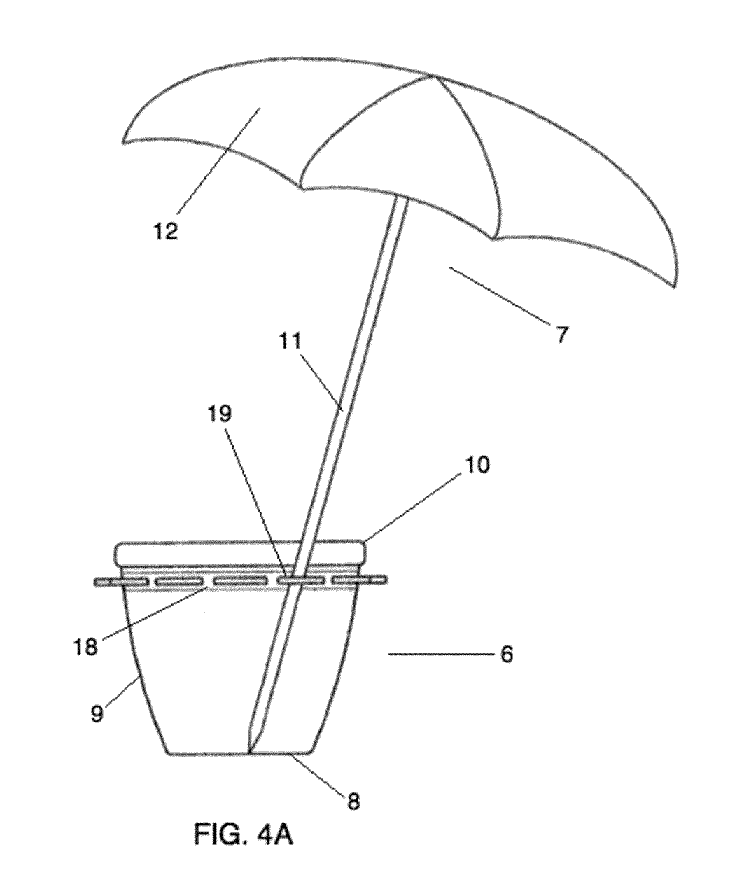

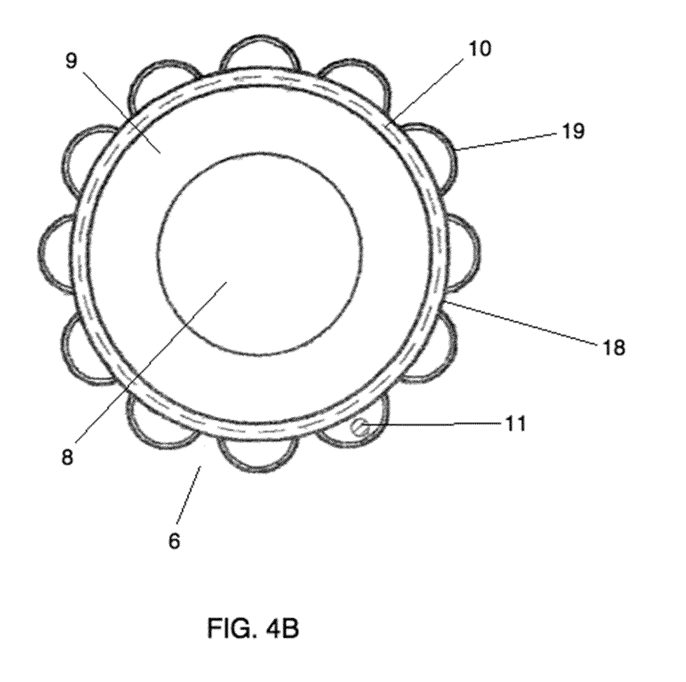

Referring now to FIG. 4A and FIG. 4B, there is shown an alternative embodiment of the present invention comprising a vessel 6 having a bottom wall 8 and a perimeter wall 9 being attached to and extending upwardly from said bottom wall 8, said perimeter wall 9 having an upper edge 10 defining an opening at the top of the vessel 6, having a band 18 secured to the external face of said perimeter wall 9 along the circumference of the upper edge 10 of said perimeter wall 9, the band 18 comprising a plurality of eyelets 19 in series extending outwardly from the face of the band 18, the eyelets 19 able to receive and support the pole 11 of an umbrella 7 extending upward from the vessel 6. The base terminus of the pole 11 is not attached to nor enveloped by any feature of the vessel 6 and is supported in its standing position only by its interaction at the point of contact with any of the plurality of eyelets 19 which encircles the pole 11 at the point of contact.

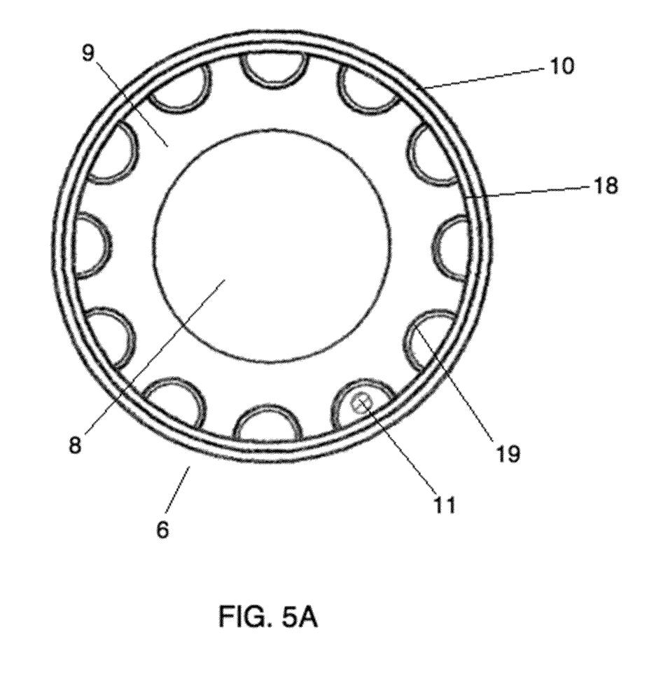

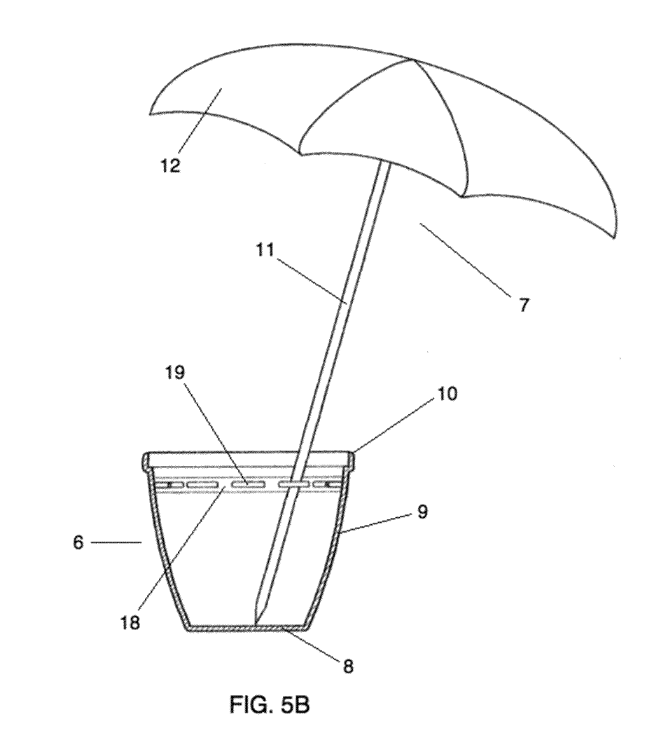

Referring now to FIG. 5A and FIG. 5B, there is shown an alternative embodiment of the present invention comprising a vessel 6 having a bottom wall 8 and a perimeter wall 9 being attached to and extending upwardly from said bottom wall 8, said perimeter wall 9 having an upper edge 10 defining an opening at the top of the vessel 6, having a band 18 secured to the internal face of said perimeter wall 9 along the circumference of the upper edge 10 of said perimeter wall 9, the band 18 comprising a plurality of eyelets 19 in series extending inwardly from the face of the band 18, the eyelets 19 able to receive and support the pole 11 of an umbrella 7 extending upward from the vessel 6. The base terminus of the pole 11 is not attached to nor enveloped by any feature of the vessel 6 and is supported in its standing position only by its interaction at the point of contact with any of the plurality of eyelets 19 which encircles the pole 11 at the point of contact. In this particular embodiment, the umbrella 7 may be further supported in its standing position by the tight packing of potting soil or such other substrate as may support plant-life within the vessel 6 around the umbrella pole 11.

In its broadest embodiment, the present invention is a vessel wherein the vessel and the contents of the vessel are sheltered from precipitation and direct sunlight by a canopy secured to the vessel.

While the foregoing written description of the invention enables one of ordinary skill to make and use what is considered presently to be the best modes thereof, those of ordinary skill will understand and appreciate the existence of variations, combinations, and equivalents of the specified embodiments, methods, and examples herein. The invention should therefore not be limited by the above described embodiment, method, and examples, but shall include all embodiments and methods within the scope and spirit of the invention as claimed.

What is claimed and described to be secured by Letters Patent is as follows:

1. A flower pot or planter apparatus comprising:
a vessel having a bottom wall and a perimeter wall being attached to and extending upwardly from said bottom wall, said perimeter wall having an upper edge defining an opening at the top of the vessel; and
means of physical support whereby said vessel may supportively engage an umbrella pole such that the umbrella may stand without need for additional support means.

2. The apparatus according to claim 1, wherein said means of physical support is a cylindrical hollow shaft extending vertically upward from the bottom wall of the vessel, the cylindrical hollow shaft having an upper edge defining an opening at the top of the shaft.

3. The apparatus according to claim 1, wherein said means of physical support is a cylindrical hollow shaft extending vertically upward from the bottom wall of the vessel, the cylindrical hollow shaft having an upper edge defining an opening at the top of the shaft, said shaft being between twenty-five (25) and one-hundred (100) percent of the height of the vessel itself.

4. The apparatus according to claim 1, wherein said means of physical support is a cylindrical hollow shaft extending vertically upward from the bottom wall of the vessel, the cylindrical hollow shaft having an upper edge defining an opening at the top of the shaft, said shaft having on its interior face spiral threaded contour defining a track in which a complimentary and inverse spiral thread contour on the exterior surface of an umbrella pole may be received, supportively engaging the umbrella.

5. The apparatus according to claim 1, wherein said means of physical support is a cylindrical hollow shaft attached to the exterior face of said perimeter wall, the cylindrical hollow shaft having an upper edge defining an opening at the top of the shaft.

6. The apparatus according to claim 5, wherein said cylindrical hollow shaft is closed at the lower terminus of said shaft.

7. The apparatus according to claim 5, wherein said shaft has on its interior face spiral threaded contour defining a track in which a complimentary and inverse spiral thread contour on the exterior surface of an umbrella pole may be received, supportively engaging the umbrella.

8. The apparatus according to claim 1, wherein said means of physical support is a band composed of a strong and rigid material featuring a plurality of eyelets in series attached about the circumference of said perimeter wall.

9. The apparatus according to claim 8, wherein said band is attached to the exterior face of said perimeter wall and the plurality of eyelets in series extend outwardly from said band and said perimeter wall.

10. The apparatus according to claim 8, wherein said band is attached to the interior face of said perimeter wall and the plurality of eyelets in series extend inwardly from said band and said perimeter wall.

11. An umbrella stand device for use in tandem with a flower pot or planter, said device comprising a horizontally planar base structure, said base structure able to lay flat in the bottom of a flower pot or planter and having a cylindrical hollow shaft extending vertically upward from the geometric center of the upper surface of the base structure, the cylindrical hollow shaft having an upper edge defining an opening at the top of the shaft.

12. The apparatus according to claim 11, wherein the horizontally planar base structure is circular, having a diameter between two (2) inches and forty-five (45) inches.

13. The apparatus according to claim 12, wherein the horizontally planar base structure is rectangular, having a width or length between two (2) inches and forty-five (45) inches.
